(19) United States
(12) Patent Application Publication
(10) Pub. No.: US 2003/0000345 A1
(43) Pub. Date: Jan. 2, 2003

(54) Simple skinning pliers

(76) Inventor: Lien-Huang Liu, Feng-Yang City (TW)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/891,281

(22) Filed: Jun. 27, 2001

(51) Int. Cl. H02G 1/12

(52) U.S. Cl. 81/9.44

(57) ABSTRACT

Simple skinning pliers including: a clamping mechanism having a first clamping member formed with a first clamping section and a second clamping member formed with a second clamping section and pivotally connected with the first clamping member, whereby the first and second clamping members can be operated to move the first and second clamping sections toward each other; and a cutting member having a predetermined length and axially reciprocally movably disposed on the first clamping section. A first adjustment section is disposed at outer end of the cutting member and positioned on outer side of the first clamping member. A blade is disposed at inner end of the cutting member and extends between the first and second clamping sections. A wire or a cable is clamped between the first and second clamping sections. By means of the first adjustment section, the depth of the blade thrusting into the insulating layer of the wire or cable can be varied.

### BACKGROUND OF THE INVENTION

The present invention is related to a hand tool for paring the insulating layer of a wire or a cable, and more particularly to a skinning pliers which has simple structure and is easily operable.

U.S. Pat. Nos. 4,955,137 and 4,945,788 disclose hand tools for paring the skin of a cable. Such hand tools have adjustable clamping sections and blades for application to various kinds of cables with different diameters or different thickness of insulating layers. However, such skinning hand tools have quite complicated structures and it is inconvenient to adjust the clamping section or the blade. Moreover, the blades of the above patents can cut the cable only in a fixed direction. Therefore, it is hard to pare the insulating layer of a small middle portion of the cable.

### SUMMARY OF THE INVENTION

It is therefore a primary object of the present invention to provide a skinning pliers which has simple structure and is manufactured and maintained at lower cost.

It is a further object of the present invention to provide the above skinning pliers which has a blade the cutting direction of which is variable.

It is still a further object of the present invention to provide the above skinning pliers in which a compressing member is additionally disposed. After a segment of insulating layer of a wire or a cable is pared off by the skinning pliers, the compressing member is able to easily firmly fix a terminal on the bare wire or cable. The compressing member is applicable to various sizes of terminals.

According to the above objects, the simple skinning pliers of the present invention includes: a clamping mechanism having a first clamping member formed with a first clamping section and a second clamping member formed with a second clamping section and pivotally connected with the first clamping member, whereby the first and second clamping members can be operated to move the first and second clamping sections toward each other; and a cutting member having a predetermined length and axially reciprocally movably disposed on the first clamping section. A first adjustment section is disposed at outer end of the cutting member and positioned on outer side of the first clamping member. A blade is disposed at inner end of the cutting member and extends between the first and second clamping sections. A wire or a cable is clamped between the first and second clamping sections. By means of the first adjustment section, the depth of the blade thrusting into the insulating layer of the wire or cable can be varied. The compressing member is disposed on the second clamping member. One end of the compressing member extends between the first and second clamping sections. The end of the wire and the terminal fitted thereon are placed between the clamping mechanism and compressed. A protruding head section of the compressing member forcedly compress and deform the terminal so as to firmly fix the terminal on the wire.

The present invention can be best understood through the following description and accompanying drawings wherein:

### BRIEF DESCRIPTION OF THE DRAWINGS

FIG. 1 is a front view of a first embodiment of the present invention in one state;

FIG. 2 is a front view of the first embodiment of the present invention in another state;

FIG. 3 is a perspective view of the casing of a second embodiment of the present invention;

FIG. 4 is a front view of the second embodiment of the present invention;

FIG. 5 is a front view of a third embodiment of the present invention;

FIG. 6 is a perspective view of the seat body of a fourth embodiment of the present invention; and

FIG. 7 is a perspective view showing that the insulating layer of a wire is cut off.

### DETAILED DESCRIPTION OF THE PREFERRED EMBODIMENTS

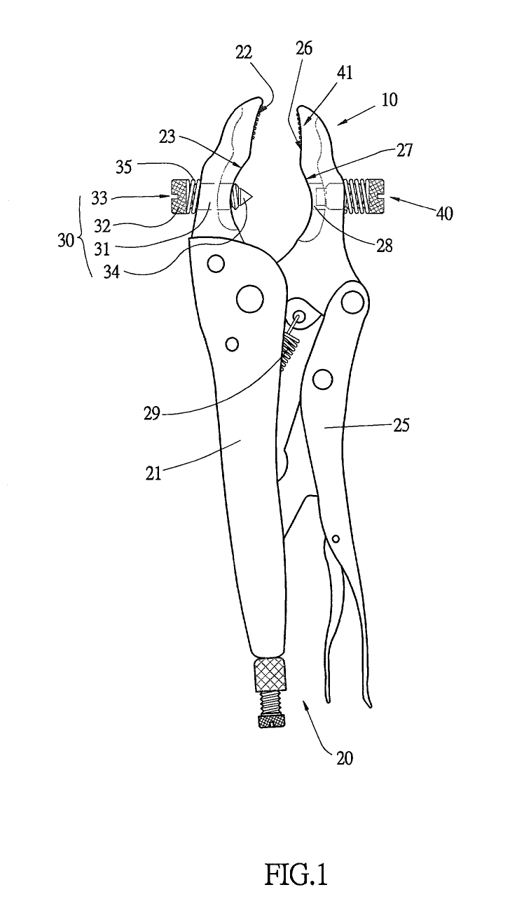

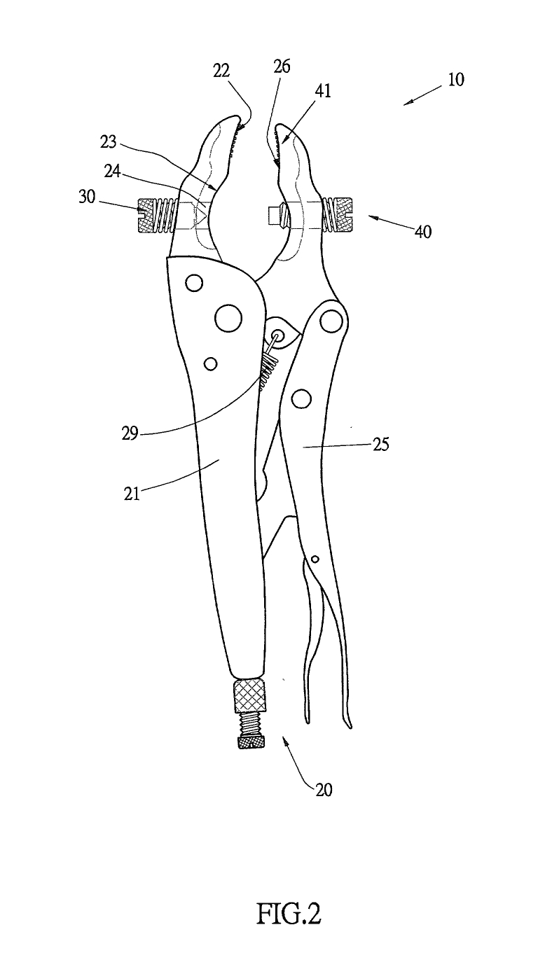

Please refer to FIGS. 1 and 2. The skinning pliers 10 of the present invention is composed of a clamping mechanism 20 for clamping a wire or a cable and a cutting member 30 and a compressing member 40 disposed on the clamping mechanism 20.

The clamping mechanism 20 has a first clamping member 21, a second clamping member 25 and a resilient member 29. The middle portion of the second clamping member 25 is pivotally connected with the middle portion of the first clamping member 21, whereby the lower ends thereof form a hold section. Two ends of the resilient member 29 are respectively connected with the first and second clamping members 21, 25 to always force the first and second clamping members 21, 25 toward each other. The first clamping member 21 has a first clamping section 22, a first recess 23 formed on a face thereof facing the second clamping member 25 and a first thread hole 24 passing through the first clamping member 21 between the outer edge thereof and the bottom of the first recess 23. The second clamping member 25 has a second clamping section 26 on one side facing the first clamping section 22, a second recess 27 formed on the second clamping section 26 and a second thread hole 28 passing through the second clamping member 25 between the outer edge thereof and the bottom of the second recess 27.

The cutting member 30 has a body section 31 extending by a certain length. The body section 31 is formed with outer thread for screwing into the first thread hole 24, whereby the body section 31 is axially reciprocally movable within the first thread hole 24. An adjustment section 32 is disposed at outer end of the body section 31 on outer side of the first clamping member 21. The circumference of the adjustment section is formed with stripes for a user's fingers to pinch and rotate. The outer end of the adjustment section is formed with a groove 33 for a screwdriver (not shown) to operate and rotate the adjustment section. A blade 34 is disposed at inner end of the body section 31 and extends between the first and second clamping sections 22, 26. A coil spring 35 is fitted around the body section 31 and positioned between the first clamping member 21 and the adjustment section 32 for maintaining the cutting member 30 in its home position.

The compressing member 40 has a shape similar to that of the cutting member 30. The compressing member 40 has a body section as a thread rod and an adjustment section positioned on outer side of the second clamping member 25. However, the inner end of the compressing member 40 is free from any blade and is instead formed with a boss extending between the first and second clamping sections 22, 26.

When a user uses the pliers 10 to pare the insulating layer of a wire, by means of the adjustment section 32, the blade 34 is slightly protruded from the bottom of the first recess 23 (as shown in FIG. 1 ). Then, the hold section of the pliers is operated so as to clamp the wire between the first and second recesses 23, 27 of the first and second clamping sections 22, 26. At this time, the blade 34 thrusts the insulating layer. Then, the user only needs to turn the wire or the pliers 10 by one circle about the axis of the wire so as to form an annular cut a on the insulating layer. Thereafter, the user loosens the wire and turns the cutting member 30 by 90 degrees. Then the wire is again clamped and the pliers 10 is moved along the axis the wire. Accordingly, the wire is cut with an elongated cut b extending from the annular cut a to the end of the wire. Therefore, the user can easily pare the cut section of insulating layer from the wire. In addition, the present invention can be also used to cut off a water tube.

When the user desires to fix a terminal (not shown) on the end of the wire free from the insulating layer, the end of the wire is first fitted into the tubular section of the terminal. Then, the cutting member 30 is adjusted to retract the blade 34 into the first thread hole 24. The compressing member 40 is adjusted to make the inner end thereof protrude from the bottom of the second recess 27 (as shown in FIG. 2 ). Then, the terminal and the wire is placed into the first recess 24 and the hold section of the pliers is operated to force the inner end of the compressing member 40 to strongly compress and deform the terminal, whereby the terminal is firmly associated with the end of the wire.

In this embodiment, the first recess 23 serves to hold the terminal and prevent the terminal from slipping. The inner end of the first thread hole 24 corresponds to the compressing member 40 so that when the inner end of the compressing member 40 compresses the terminal, the end of the terminal is easily deformed and fixed with the wire.

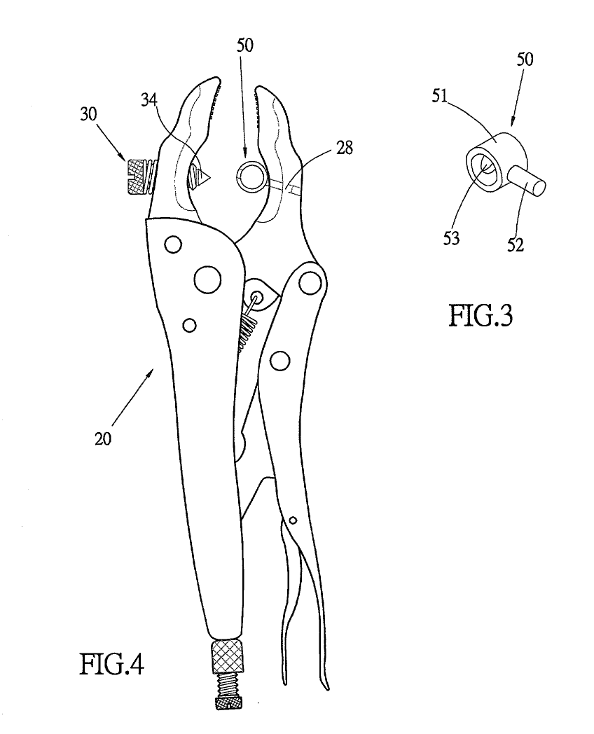

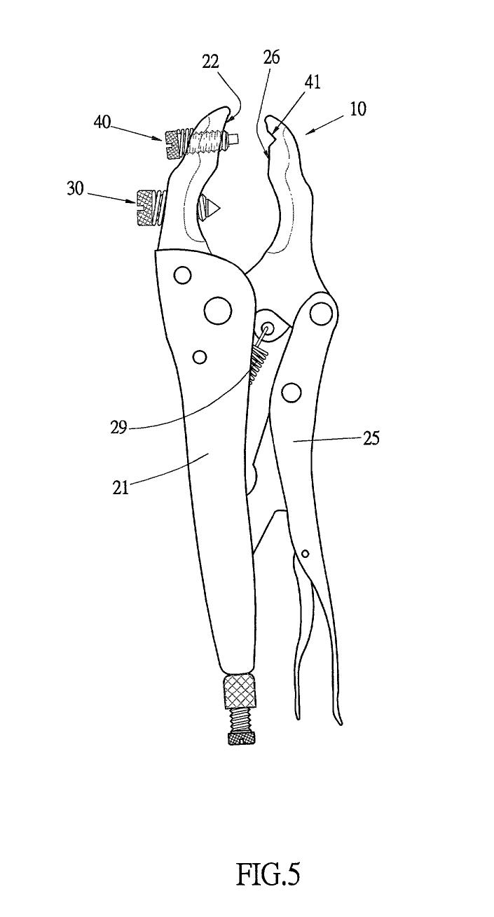

Referring to FIGS. 3 and 4, the skinning pliers 10 of the present invention can be used in cooperation with a casing 50. The casing 50 has a long tube 51, an insertion leg 52 having a certain length and disposed on outer side of the long tube 51 and an opening 53 formed on a lateral side of the long tube 51. In use, the insertion leg 52 is first inserted into the second thread hole 28 to fix the casing 50 on the second clamping member 25. Then, a wire is passed through the long tube 51 and the first and second clamping sections 22, 26 are forced to get close to each other. The tip of the blade 34 is extended through the opening 53 into the long tube 51 to cut the insulating layer of the wire and form a cut thereon. The main function of the casing 50 is that the opening 53 serves to restrict the length of the tip of the blade 34 extending into the long tube 51. Therefore, this is applicable to those situations necessitating high precision, for example, cutting of an optic fiber cable.

FIG. 5 shows another embodiment of the present invention, in which the cutting member 30 and the compressing member 40 are together disposed on the first clamping member 21. The second clamping section 26 is formed with a wedge-shaped notch 41 for placing a terminal thereon. The notch 41 corresponds to the inner end of the compressing member 40.

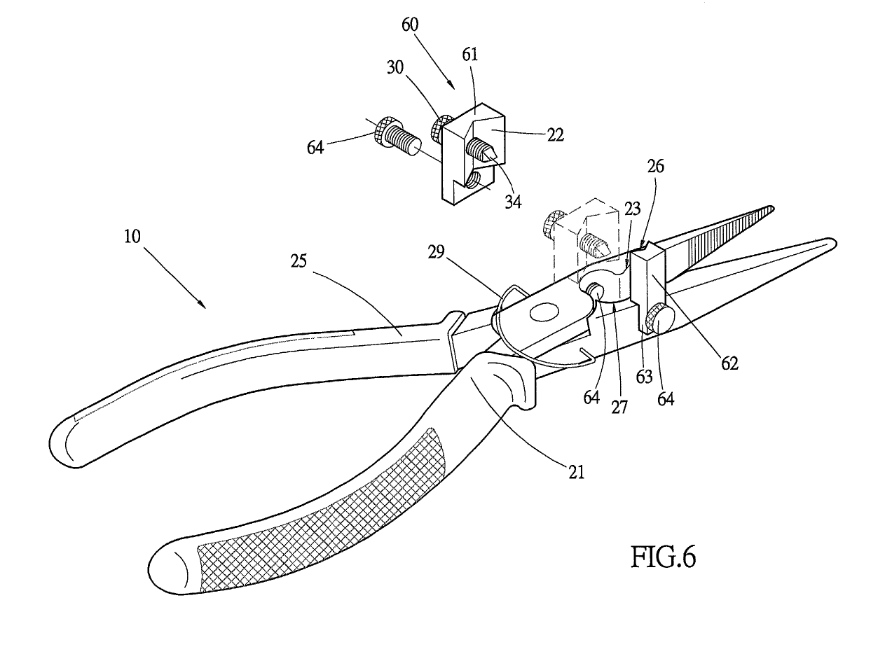

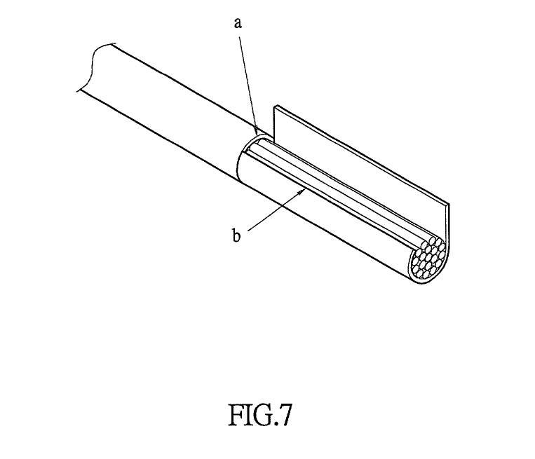

FIG. 6 shows still another embodiment of the present invention, in which a simple pliers is equipped with a first seat body 60 and a second seat body 62 respectively fixable on the first and second clamping members 21, 25. The opposite end faces of the first and second seat bodies 60, 62 are respectively formed with a first and a second recessed clamping sections 22, 26 for easily clamping a wire therebetween. The lateral sides of the first and second clamping sections 22, 26 are respectively formed with extension sections 61, 63 locked on the first and second clamping members 21, 25 by screws 64 screwed in the first and second thread holes 24, 28. The cutting member 30 is screwed in the first seat body 60. The blade 34 can extend between the first and second seat bodies 60, 62. In this embodiment, the resilient member 29 is arched and has two ends as reverse hooks previously inlaid in the dents formed on outer sides of the first and second clamping members 21, 25. The resilient member 29 serves to forcedly close the first and second clamping members 21, 25. In addition, by means of the arched resilient member 29, the pliers can be hung on a wall face.

The above embodiments are only used to illustrate the present invention, not intended to limit the scope thereof. Many modifications of the above embodiments can be made without departing from the spirit of the present invention.

What is claimed is:

1. Simple skinning pliers comprising:
a clamping mechanism having a first clamping member formed with a first clamping section and a second clamping member formed with a second clamping section, the first and second clamping members being pivotally connected with each other at predetermined portions, whereby the first and second clamping members can be operated to make the first and second clamping sections get close to each other; and
a cutting member having a predetermined length and axially reciprocally movably disposed on the first clamping section, a first adjustment section being disposed at outer end of the cutting member and positioned on outer side of the first clamping member, a blade being disposed at inner end of the cutting member and extending between the first and second clamping sections.

2. Simple skinning pliers as claimed in claim 1, wherein the first clamping member is formed with a thread hole passing through the first clamping member between the outer side thereof and the first clamping section, the cutting member having a body section as a thread rod screwed in the thread hole and formed between the first adjustment section and the blade.

3. Simple skinning pliers as claimed in claim 2, wherein the first clamping section is formed with a first recess and the thread hole extends between the bottom of the first recess and the outer edge of the first clamping member.

4. Simple skinning pliers as claimed in claim 1, wherein the second clamping section is formed with a second recess facing the first clamping section and corresponding to inner end of the cutting member.

5. Simple skinning pliers as claimed in claim 3, wherein the second clamping section is formed with a second recess facing the first clamping section and corresponding to inner end of the cutting member.

6. Simple skinning pliers as claimed in claim 1, further comprising a compressing member with a predetermined length, the compressing member being axially reciprocally movably disposed on the second clamping section, a second adjustment section being disposed at outer end of the compressing member and positioned on outer side of the second clamping member, a head section being disposed at inner end of the compressing member and extending between the first and second clamping sections.

7. Simple skinning pliers as claimed in claim 6, wherein the second clamping member is formed with a thread hole passing through the second clamping member between the outer side thereof and the second clamping section, the compressing member having a body section as a thread rod screwed in the thread hole and formed between the second adjustment section and the head section.

8. Simple skinning pliers as claimed in claim 1, further comprising a compressing member with a predetermined length, the compressing member being axially reciprocally movably disposed on the first clamping section, a second adjustment section being disposed at outer end of the compressing member and positioned on outer side of the first clamping member, a head section being disposed at inner end of the compressing member and extending between the first and second clamping sections.

9. Simple skinning pliers as claimed in claim 1, further comprising a casing having a long tube with a predetermined inner diameter, an opening being formed on a lateral side of the long tube, an insertion leg projecting from outer side of the long tube, the second clamping section being formed with a socket in which the insertion leg is inserted with the opening opposite to the inner end of the blade.

10. Simple skinning pliers as claimed in claim 1, further comprising a resilient member two ends of which are respectively connected with the first and second clamping members for forcing the first and second clamping sections to get close to each other.

11. Simple skinning pliers as claimed in claim 1, further comprising a first seat body disposed on the first clamping member and a
